(19) United States
(12) Patent Application Publication
(10) Pub. No.: US 2006/0093201 A1
(43) Pub. Date: May 4, 2006

(54) Image display apparatus, image display method, and image display program

(75) Inventor: Hideya Takeo, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/260,191

(22) Filed: Oct. 28, 2005

(30) Foreign Application Priority Data
Oct. 28, 2004 (JP) 313801/2004

(51) Int. Cl. G06K 9/00

(52) U.S. Cl. 382/132; 715/964

(57) ABSTRACT

Positive recognition of whether a displayed diagnostic image is a non-CAD processed image or a CAD processed image, in which abnormal patterns were not detected, is enabled. An image display apparatus judges whether CAD result data accompanies data obtained for display. If it is judged that CAD result data accompanies the data, a type image that represents that the image is a CAD processed image, for example, an image that indicates the number of detected abnormal patterns (including zero), is displayed along with the CAD processed image. If it is judged that CAD result data does not accompany the data, a type image that represents that the image is a non-CAD processed image, for example, an image that does not indicate the number of detected abnormal patterns, is displayed along with the non-CAD processed image. An image that represents the detection sensitivity of the CAD process is also displayed.

### BACKGROUND OF THE INVENTION

1. Field of the Invention

The present invention relates to a method and an apparatus for displaying diagnostic images that reflect detection results of abnormal pattern detection processes. The present invention also relates to a program that causes a computer to execute the method.

2. Description of the Related Art

Abnormal pattern detection processing systems (computer aided image diagnostic apparatuses) have been proposed, in U.S. Pat. No. 5,761,334, for example. These systems automatically detect abnormal patterns within diagnostic images of subjects, based on diagnostic image data sets that represent the diagnostic images.

These systems comprise: an abnormal pattern detecting apparatus, for administering abnormal pattern detecting processes on the diagnostic image data sets that represent the diagnostic images to detect abnormal patterns therein and for outputting detection process result data that represents the detection results; and an image display apparatus, for displaying the diagnostic images represented by the diagnostic image data sets.

If the detection process result data regarding a diagnostic image data set is obtained by administering the abnormal pattern detecting process thereon, the image display apparatus employs the data when displaying the diagnostic image represented by the diagnostic image data set. Specifically, in the case that abnormal patterns are detected, the data is employed to display an image, in which the positions of the detected abnormal patterns are indicated, as a post-detection process image. In the case that abnormal patterns are not detected, the data is employed to display an image, in which positions of abnormal patterns are not indicated, as a post-detection process image. If a diagnostic image data set, which is not accompanied by the detection process result data, is obtained by the image display apparatus, the image display apparatus displays a normal diagnostic image, in which the detection results are not reflected, as a pre-detection process image.

This image display apparatus displays desired pre-detection process images or post-detection process images, depending on the data that an operator provides thereto. The image display apparatus enables confirmation of diagnostic images, on which abnormal pattern detecting processes are to be administered, or enables diagnosis based on the post-detection process images, in which the diagnosis aiding data is included.

However, the data that indicates the positions of abnormal patterns is not included in the post-detection process images displayed by the image display apparatus in cases in which abnormal patterns are not detected by the abnormal pattern detecting process. Therefore, the post-detection process images in these cases are displayed in a similar manner to pre-detection process images, in which detection results of the abnormal pattern detecting process are not reflected. Accordingly, there are cases in which it can not be distinguished whether an image is a pre-detection process image or a post-detection process image in which abnormal patterns were not detected, by viewing the image. For this reason, there is a possibility that a radiologist will inadvertently misinterpret a pre-detection process image as being a post-detection process image in which abnormal patterns were not detected, and perform diagnosis without consulting effective diagnosis aiding data.

This problem becomes grave, especially in cases in which the radiologist has limited experience in image diagnosis, and relies heavily on the diagnosis aiding data included in post-detection process images to make diagnoses.

### SUMMARY OF THE INVENTION

The present invention has been developed in view of the foregoing circumstances. It is an object of the present invention to provide a method and apparatus for displaying images that enable positive recognition regarding whether a displayed diagnostic image is a pre-detection process image, in which detection results of abnormal pattern detection processes are not reflected, or a post-detection process image, in which detection results of abnormal pattern detection processes are reflected.

The image display apparatus of the present invention comprises:

data obtaining means, for obtaining: a diagnostic image data set that represents a diagnostic image of a subject; and detection process result data, obtained by administering an abnormal pattern detecting process for detecting abnormal patterns within the diagnostic image represented by the diagnostic image data set, including the positions of the abnormal patterns in the case that the abnormal patterns are detected, to accompany the diagnostic image data set; or a diagnostic image data set, which is not accompanied by the detection process result data;

data judging means, for judging whether the data set obtained by the data obtaining means is accompanied by the detection process result data;

display means, for displaying images; and

display control means, for: displaying the diagnostic image data set as a pre-detection process image if the judging means judges that the data set is not accompanied by the detection process result data; for generating and displaying an image that indicates the positions of the abnormal patterns, if the judging means judges that the data set is accompanied by the detection process result data and in the case that the abnormal patterns are specified by the detection process result data; and for generating and displaying an image that does not indicate the positions of abnormal patterns if the judging means judges that the data set is accompanied by the detection process result data and in the case that abnormal patterns are not specified by the detection process result data;

the display control means displays information that represents the type of image being displayed, from between a pre-detection process image type and a post-detection process image type, when displaying the image, based on the judgment results of the data judging means.

Here, the “diagnostic image” refers to an image which is provided for image diagnosis. Examples of such images include: radiation images, CT (Computed Tomography) images, MRI images, and RI images.

The “image that does not indicate the positions of abnormal patterns” may be the original diagnostic image represented by the input diagnostic image data set.

Examples of the “abnormal pattern detecting process” include: an iris filter process, which is effective in detecting tumor patterns, and a morphology filter process, which is effecting in detecting calcification patterns. Details of these processes are included in the disclosures of the aforementioned U.S. Patent.

The “information that represents the type of image” may be symbols, markings, or text, which are determined in advance to represent either the pre-detection process image or the post-detection process image. Alternatively, the pattern or the color of the border of the displayed image may be changed according to the type of image.

Examples of the “display means” include: CRT's (Cathode Ray Tube displays), LCD's (Liquid Crystal Displays), and projectors.

Note that it is preferable that the detection process result data includes data that represents the number of abnormal patterns detected by the abnormal pattern detecting process; and the display control means displays the number of the detected abnormal patterns when displaying the post-detection process image. If this configuration is adopted, the displayed number of abnormal patterns can be compared against the number of abnormal patterns visually confirmed within the image, thereby avoiding overlooking of the detected abnormal patterns.

In addition, a configuration may be adopted, wherein: the abnormal pattern detecting process detects the abnormal patterns employing one of a plurality of detection sensitivities; the detection process result data includes data that represents the detecting sensitivity employed in the abnormal pattern detecting process administered on the diagnostic image data set; and the display control means also displays information representing the detection sensitivity, when displaying the post-detection process image.

Here, the “detection sensitivity” refers to a percentage of true abnormal patterns, which are accurately detected. Generally, there is a tendency that if the detection sensitivity is increased, the detection rate (the ratio of the number of true abnormal patterns which are detected, with respect to the number of true abnormal patterns that are present) rises, but the number of false positives (erroneously detected normal patterns) also rises. If the detection sensitivity is decreased, the number of false positives is reduced, but the detection rate also deteriorates.

The program of the present invention causes a computer to function as:

data obtaining means, for obtaining: a diagnostic image data set that represents a diagnostic image of a subject; and detection process result data, obtained by administering an abnormal pattern detecting process for detecting abnormal patterns within the diagnostic image represented by the diagnostic image data set, including the positions of the abnormal patterns in the case that the abnormal patterns are detected, to accompany the diagnostic image data set; or a diagnostic image data set, which is not accompanied by the detection process result data;

data judging means, for judging whether the data set obtained by the data obtaining means is accompanied by the detection process result data;

display means, for displaying images; and

display control means, for: displaying the diagnostic image data set as a pre-detection process image if the judging means judges that the data set is not accompanied by the detection process result data; for generating and displaying an image that indicates the positions of the abnormal patterns, if the judging means judges that the data set is accompanied by the detection process result data and in the case that the abnormal patterns are specified by the detection process result data; and for generating and displaying an image that does not indicate the positions of abnormal patterns if the judging means judges that the data set is accompanied by the detection process result data and in the case that abnormal patterns are not specified by the detection process result data; wherein

information that represents the type of image being displayed, from between a pre-detection process image type and a post-detection process image type, is displayed when displaying the image, based on the judgment results of the data judging means.

In the program of the present invention, it is preferable that the detection process result data includes data that represents the number of abnormal patterns detected by the abnormal pattern detecting process; and the display control means displays the number of the detected abnormal patterns when displaying the post-detection process image.

In addition, a configuration may be adopted, wherein: the abnormal pattern detecting process detects the abnormal patterns employing one of a plurality of detection sensitivities; the detection process result data includes data that represents the detecting sensitivity employed in the abnormal pattern detecting process administered on the diagnostic image data set; and the display control means also displays information representing the detection sensitivity when displaying the post-detection process image.

Note that the program of the present invention may be provided being recorded on a computer readable medium. Those who are skilled in the art would know that computer readable media are not limited to any specific type of device, and include, but are not limited to: floppy disks, CD's, RAM's, ROM's, hard disks, magnetic tapes, and internet downloads, in which computer instructions can be stored and/or transmitted. Transmission of the computer instructions through a network or through wireless transmission means is also within the scope of the present invention. Additionally, computer instructions include, but are not limited to: source, object, and executable code, and may be in any language, including higher level languages, assembly language, and machine language.

The image display method of the present invention comprises the steps of:

obtaining: a diagnostic image data set that represents a diagnostic image of a subject; and detection process result data, obtained by administering an abnormal pattern detecting process for detecting abnormal patterns within the diagnostic image represented by the diagnostic image data set, including the positions of the abnormal patterns in the case that the abnormal patterns are detected, to accompany the diagnostic image data set; or a diagnostic image data set, which is not accompanied by the detection process result data;

judging whether the data set obtained by the data obtaining means is accompanied by the detection process result data;

displaying the diagnostic image data set as a pre-detection process image if it is judged that the data set is not accompanied by the detection process result data; generating and displaying an image that indicates the positions of the abnormal patterns, if it is judged that the data set is accompanied by the detection process result data and in the case that the abnormal patterns are specified by the detection process result data; and for generating and displaying an image that does not indicate the positions of abnormal patterns if it is judged that the data set is accompanied by the detection process result data and in the case that abnormal patterns are not specified by the detection process result data; wherein

information that represents the type of image being displayed, from between a pre-detection process image type and a post-detection process image type, is displayed when displaying the image, based on the judgment results of the data judging means.

In the image display method of the present invention, it is preferable that the detection process result data includes data that represents the number of abnormal patterns detected by the abnormal pattern detecting process; and the number of the detected abnormal patterns is displayed when displaying the post-detection process image.

In addition, a configuration may be adopted, wherein: the abnormal pattern detecting process detects the abnormal patterns employing one of a plurality of detection sensitivities; the detection process result data includes data that represents the detecting sensitivity employed in the abnormal pattern detecting process administered on the diagnostic image data set; and information representing the detection sensitivity is also displayed when displaying the post-detection process image.

The image display method, the image display apparatus and the image display program of the present invention display information that represents the type of image being displayed, based on whether the data set obtained by the apparatus or the computer functioning as the apparatus is accompanied by detection process result data. Accordingly, it becomes possible to distinguish whether an image is a pre-detection process image or a post-detection process image in which abnormal patterns were not detected, by viewing the image, unlike in the conventional image display apparatus. Therefore, positive recognition regarding whether a displayed diagnostic image is a pre-detection process image, in which detection results of abnormal pattern detection processes are not reflected, or a post-detection process image, in which detection results of abnormal pattern detection processes are reflected, is enabled.

### BRIEF DESCRIPTION OF THE DRAWINGS

FIG. 1 is a schematic block diagram that illustrates the construction of a CAD processing system according to a first embodiment of the present invention.

FIG. 2 illustrates a display screen of a display section, on which non-CAD processed images are displayed.

FIG. 3 illustrates a display screen of a display section, on which CAD processed images are displayed.

FIG. 4 is a schematic block diagram that illustrates the construction of a CAD processing system according to a second embodiment of the present invention.

FIG. 5 is a schematic block diagram that illustrates the construction of a viewer.

FIG. 6 illustrates the display screen of the display section, in which version images are displayed within small regions.

FIG. 7 illustrates the display screen of the display section, in which a version image is displayed in a pop up window.

FIG. 8 is a graph that illustrates the relationship between detection rates of abnormal patterns and numbers of false positive detections.

FIG. 9 illustrates the display screen of the display section, in which a sensitivity parameter image is displayed.

### DESCRIPTION OF THE PREFERRED EMBODIMENTS

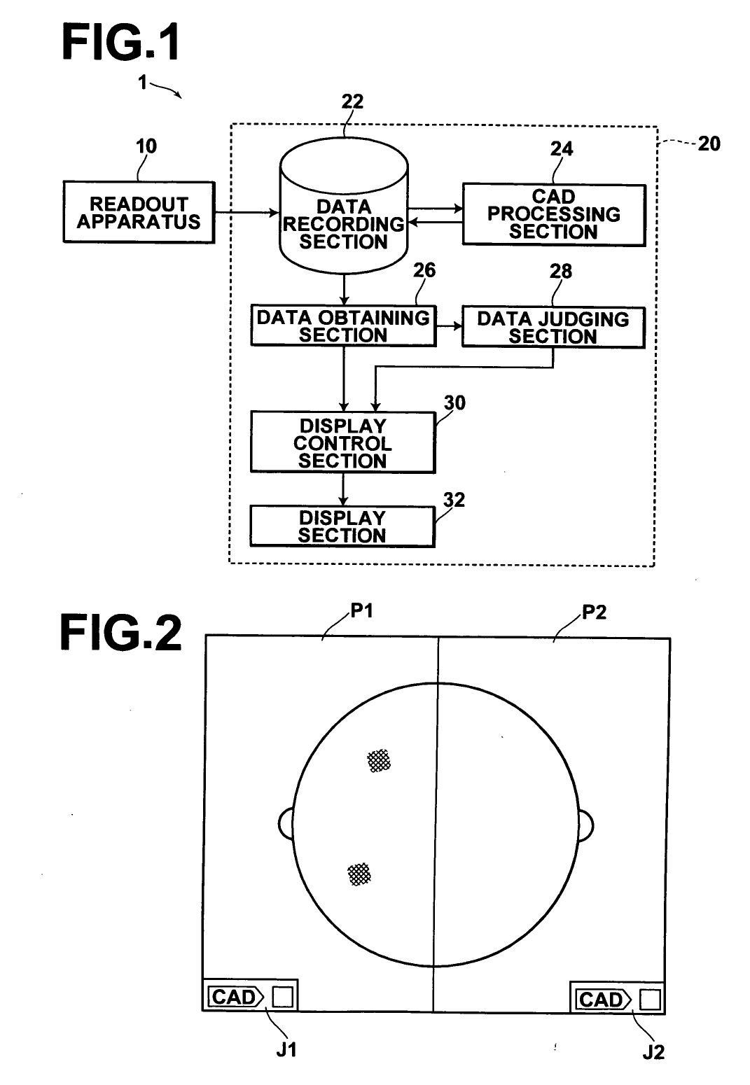

Hereinafter, embodiments of the present invention will be described in detail with reference to the attached drawings. FIG. 1 is a schematic block diagram that illustrates the construction of a CAD (Computer Aided Detection) processing system 1 according to a first embodiment of the present invention. As illustrated in FIG. 1, the CAD processing system 1 comprises: a readout apparatus 10; and a computer terminal 20. The computer terminal 20 comprises: a data recording section 22; a CAD processing section 24 (abnormal pattern detection processing means); a data obtaining section 26; a data judging section 28; a display control section 30; and a display section 32. Note that the data obtaining section 26, the data judging section 28; the display control section 30, and the display section 32 function as the image display apparatus of the present invention.

The readout apparatus 10 obtains diagnostic image data sets that represent radiation images. The diagnostic image data sets are obtained by: scanning recording media, such as stimulable phosphor sheets on which radiation image information has been recorded by radiography of subjects, with a laser beam as excitation light, thereby causing light that includes the radiation image information to be emitted; and photoelectrically reading out the emitted light. The obtained diagnostic image data sets are transmitted to the data recording section 22 of the computer terminal 20. In the present embodiment, mammograms (radiographic images of patients' breasts) are obtained as the diagnostic image data sets.

The data recording section 22 receives the diagnostic image data sets transmitted thereto from the readout apparatus 10, generates list data files for recording various types of data regarding the received diagnostic image data sets, and stores the list data files correlated with the diagnostic image data sets. In addition, the data recording section 22 receives CAD process result data (detection process result data), generated by the CAD processing section 24 to be described in detail later, CAD process confirmation data and the like, regarding each of the diagnostic image data sets, and records the data in the list data file correlated therewith.

The CAD processing section 24 reads out a diagnostic image data set from the data recording section 22, according to input requesting CAD processing from an operator. The CAD processing section 24 administers a CAD process (abnormal pattern detecting process), for detecting abnormal patterns within the radiation image represented by the diagnostic image data set, on the diagnostic image data set, and generates CAD process result data that represents the detection results. The CAD process result data includes data representing the number of detected abnormal patterns, and the positions of the detected abnormal patterns, in the case that abnormal patterns are detected by the CAD process. In addition, the CAD processing section 24 generates CAD process confirmation data that represents that the CAD process has been properly completed, in the case that the CAD process is properly completed. The CAD process result data and the CAD process confirmation data are transmitted to the data recording section 22, and recorded in the list data file correlated with the diagnostic image data set which was subject to the CAD process.

The data obtaining section 26 obtains a diagnostic image data set, which is not accompanied by CAD process result data, or a diagnostic image data set, which is accompanied by CAD process result data, from the data recording section, according to input from an operator or according to predetermined settings. Note that in the present embodiment, the CAD process result data is obtained in the following manner. First, list data files correlated with the diagnostic image data sets, which are the targets of obtainment, are searched, to confirm whether CAD process confirmation data are recorded therein. In the case that the CAD process confirmation data is recorded in a list data file, the CAD process result data is read out therefrom.

The data judging section 28 judges whether the diagnostic image data set is accompanied by the CAD process result data, based on the data obtained by the data obtaining section 26.

In response to judgment by the data judging section 28 that a diagnostic image data set is not accompanied by CAD process result data, the display control section 30 causes the display section 32 to display the diagnostic image represented by the diagnostic image data set as a non-CAD processed image (pre-detection process image). In response to judgment by the data judging section 28 that a diagnostic image data set is accompanied by CAD process result data, and in the case that abnormal patterns are specified in the CAD process result data, the display control section 30 generates an image, in which positions of the abnormal patterns are indicated within the diagnostic image. The generated image is displayed at the display section 32 as a CAD processed image (post-detection process image). At this time, the display control section 30 judges whether the image to be displayed is a non-CAD processed image or a CAD processed image, based on the judgment results of the data judging section 28. Information that represents the type of image to be displayed is displayed at the display section 32, along with the image. In the present embodiment, a type image that represents whether a CAD process has been administered is displayed within a small region within a display screen of the display section. In the case that the image is a non-CAD processed image, “CAD:_” is displayed within the type image region. In the case that the image is a CAD processed image, in which abnormal patterns were not detected, “CAD:0” is displayed within the type image region. In the case that the image is a CAD processed image, in which abnormal patterns were detected, “CAD:[number of abnormal patterns]” is displayed in the type image region. Note that “CAD:!” may be displayed in the type image region for CAD processed images, regardless of the number of detected abnormal patterns.

Next, the processes performed by the present embodiment will be described. Note that here, an example will be described in which: a radiologist (an operator) causes a non-CAD processed mammogram of a single patient to be displayed at the display section 32; administers a CAD process on a diagnostic image data set that represents the mammogram; and causes a CAD processed image, in which the detection results of abnormal patterns are reflected, to be displayed as a reference image for diagnosis.

First, the readout apparatus 10 reads out radiation image information from recording media, and obtains a pair of diagnostic image data sets that represent mammograms of the right and left breasts of a patient. The pair of obtained diagnostic image data sets are output to the data recording section 22. After receiving the diagnostic image data sets from the readout apparatus 10, the data recording section generates list data files corresponding to each of the diagnostic image data sets of the pair, and stores the list data files correlated with the diagnostic image data sets.

The data obtaining section 26 obtains only the pair of diagnostic image data sets from the data recording section 22, according to input requesting display of the images read out by the readout apparatus 10 from the operator. The data judging section 28 judges that the pair of diagnostic image data sets obtained by the data obtaining section 26 are not accompanied by CAD process result data.

In response to the judgment by the data judging section 28 that the diagnostic image data sets are not accompanied by CAD process result data, the display control section 30 displays radiation images P1 and P2 represented by each or the diagnostic image data sets on the same display screen of the display section 32, as illustrated in FIG. 2. At the same time, type images J1 and J2 that represent that the radiation images are non-CAD processed images, that is, “CAD:_”, are displayed at the lower right and the lower left portion of the display screen of the display section 32 corresponding to each of the radiation images P1 and P2.

At this time, the operator can recognize that the radiation images P1 and P2 are non-CAD processed images, by visually confirming the type images J1 and J2 displayed at the display section 32. Accordingly, even if there are circumstances that cause the radiologist to not be able to concentrate during the procedures of administering CAD processes on diagnostic image data sets and causing the CAD processed images to be displayed, the radiologist can recognize that the radiation images displayed at the display section 32 are non-CAD processed images, by viewing the type images also displayed thereat. Therefore, the radiologist will not misinterpret the non-CAD processed images as CAD processed images, in which abnormal patterns were not detected.

Next, the CAD processing section 24 reads out the pair of diagnostic images from the data recording section 22, according to input requesting CAD processing from the operator. CAD processes are administered on each of the pair of diagnostic image data sets, abnormal patterns within the mammograms represented by the diagnostic image data sets are detected, and CAD process confirmation data and CAD process result data that includes data representing the number of detected abnormal patterns are generated. The generated CAD process confirmation data and CAD process result data are transmitted to the data recording section 22, and recorded in the list data files that correspond to the diagnostic image data sets that the data was generated for.

After the CAD process confirmation data are recorded in the list data files, the data obtaining section 26 obtains the pair of diagnostic image data sets from the data recording section 22, and reads out the CAD process result data from the list data files corresponding thereto. The data judging section 28 judges that the diagnostic image data sets obtained by the data obtaining section 26 are accompanied by CAD process result data.

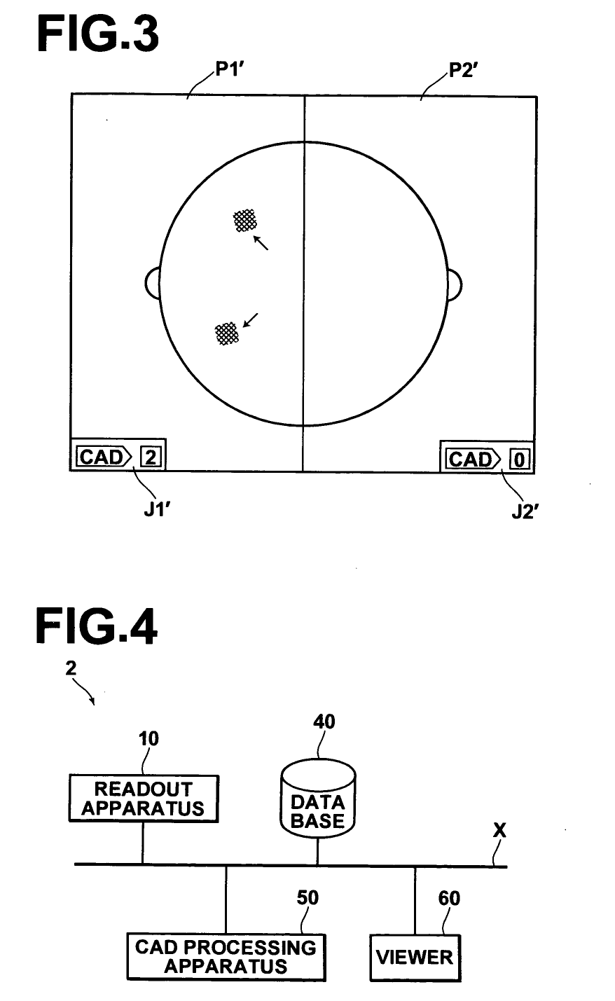

In response to the judgment by the data judging section 28 that the obtained diagnostic image data sets are accompanied by the CAD process result data, the display control section 30 processes each combination of the diagnostic image data sets and the CAD process result data as follows. In the case that the CAD process result data specifies abnormal patterns, a radiation image, in which the positions of the abnormal patterns are indicated, is generated. In the case that the CAD process result data does not specify abnormal patterns, a radiation image, in which positions of abnormal patterns are not indicated, is generated. Then, the display control section 30 displays the generated images P1′ and P2′ on the same display screen of the display section 32, as illustrated in FIG. 3. At the same time, type images J1′ and J2′ that represent that the radiation images are CAD processed images, that is, “CAD:[number of abnormal patterns]”, are displayed at the lower right and the lower left portion of the display screen of the display section 32 corresponding to each of the radiation images P1′ and P2′. Here, type image J1′ is an example of a case in which the number of abnormal patterns is two, and type image J2′ is an example of a case in which the number of abnormal patterns is 0, that is, a case in which no abnormal patterns were detected.

At this time, the operator can recognize that the radiation images P1′ and P2′ are CAD processed images, by visually confirming the type images J1′ and J2′ displayed at the display section 32.

In this manner, according to the present embodiment, information that represents the type of image being displayed, based on whether the data set obtained by the data obtaining section 26 is accompanied by CAD process result data, along with the displayed image. For this reason, it becomes possible to distinguish whether an image is a non-CAD processed image or a CAD processed image in which abnormal patterns were not detected, by viewing the image, unlike in conventional image display apparatuses. Therefore, positive recognition regarding whether a displayed diagnostic image is a non-CAD processed image, in which detection results of a CAD process are not reflected, or a CAD processed image, in which detection results of a CAD process are reflected, is enabled.

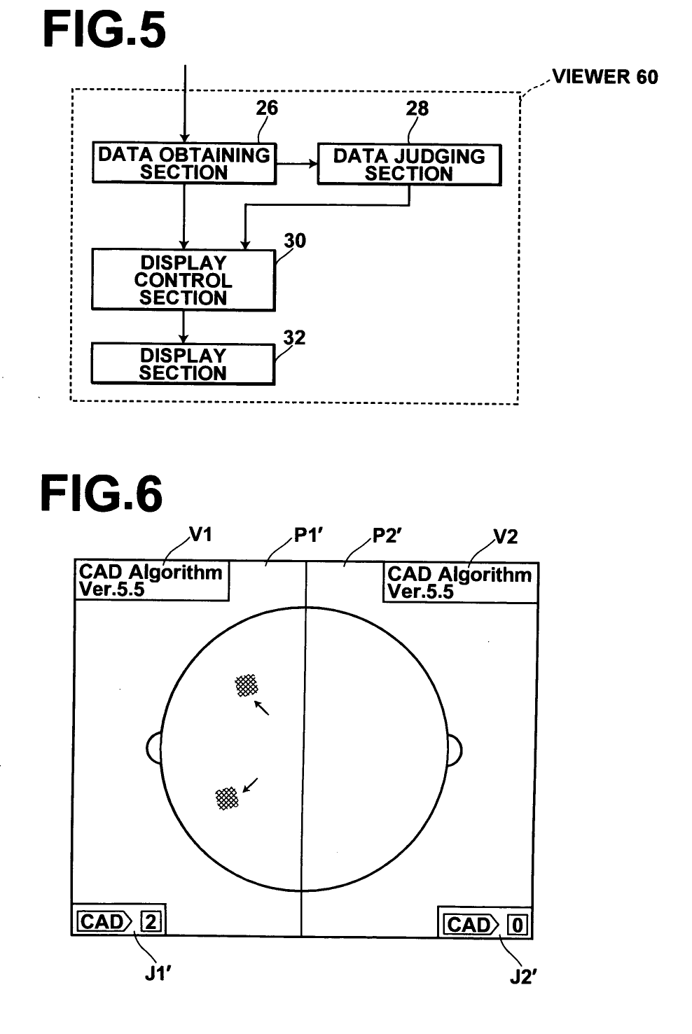

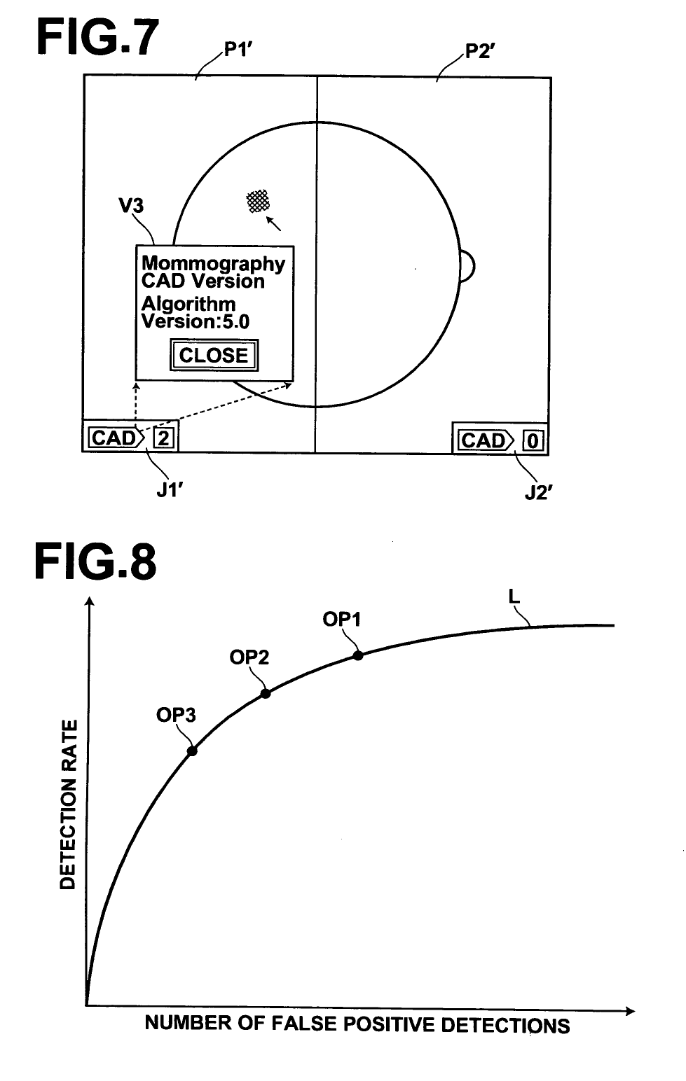

Next, a second embodiment of the present invention will be described. FIG. 4 is a schematic block diagram that illustrates the construction of a CAD processing system 2 according to the second embodiment. Note that elements of the CAD processing system 2 which are the same as those of the CAD processing system 1 of the first embodiment will be denoted with the same reference numerals, and detailed descriptions thereof will be omitted insofar as they are not necessary. As illustrated in FIG. 4, the CAD processing system 2 comprises: a readout apparatus 10; a database 40; a CAD processing apparatus 50; and a viewer 60 (image display apparatus). The constituent parts of the CAD processing system 2 are connected via a network X. As illustrated in FIG. 5, the viewer 60 comprises: a data obtaining section 26; a data judging 28; a display control section 30; and a display section 32.

The readout apparatus 10 obtains diagnostic image data sets that represent radiation images. The diagnostic image data sets are obtained by: scanning recording media, such as stimulable phosphor sheets on which radiation image information has been recorded by radiography of subjects, with a laser beam as excitation light, thereby causing light that includes the radiation image information to be emitted; and photoelectrically reading out the emitted light. The obtained diagnostic image data sets are transmitted to the database 40, the CAD processing apparatus 50, or the viewer 60, as will be described later. In the present embodiment as well, mammograms (radiographic images of patients' breasts) are obtained as the diagnostic image data sets.

The database 40 stores therein a great number of diagnostic image data sets. The database 40 stores diagnostic image data sets transmitted thereto from the readout apparatus 10 therein. The database 40 also stores diagnostic image data sets, on which CAD processes have been administered by the CAD processing apparatus 50 to be described later, and CAD process result data obtained by the cad processes, correlated with each other therein.

The CAD processing apparatus 50 receives predetermined diagnostic images from the readout apparatus 10 or the database 40, according to input requesting CAD processing from the operator. The CAD processing apparatus 50 administers a CAD process (abnormal pattern detecting process), for detecting abnormal patterns within the radiation image represented by the diagnostic image data set, on the diagnostic image data set, and generates CAD process result data that represents the detection results. The CAD process result data includes data representing the number of detected abnormal patterns, and the positions of the detected abnormal patterns, in the case that abnormal patterns are detected by the CAD process. In addition, the CAD process result data includes CAD process confirmation data that represents that the CAD process has been properly completed, in the case that the CAD process is properly completed. The CAD process result data is transmitted to the database 40 or to the viewer 60, attached to the diagnostic image data set. Note that in the Dicom standard, image data sets have attached data called “Structured Reports”. In this case, the CAD process result data may be included in the attached data. In the case that the CAD process is not administered on a diagnostic image data set, the attached data field is blank.

The data obtaining section 26, the data judging section 28, the display control section 30, and the display section 32 that constitute the viewer 60 have the same functions as those of the first embodiment.

Next, the processes performed by the present embodiment will be described. In the present embodiment, there are three paths through which the data obtaining section 26 of the viewer obtains diagnostic image data sets. That is, the diagnostic image data sets may be obtained from any one of the readout apparatus 10, the database 40, and the CAD processing apparatus 50. Therefore, each case will be described below.

[Obtaining Diagnostic Image Data Sets from the Readout Apparatus]

The readout apparatus 10 reads out radiation image information from recording media, and obtains a pair of diagnostic image data sets that represent mammograms of the right and left breasts of a patient. The pair of obtained diagnostic image data sets are output to the viewer 60. The data judging section 28 judges that the pair of diagnostic image data sets obtained by the data obtaining section 26 are not accompanied by CAD process result data.

In response to the judgment by the data judging section 28 that the diagnostic image data sets are not accompanied by CAD process result data, the display control section 30 displays radiation images P1 and P2 represented by each or the diagnostic image data sets on the same display screen of the display section 32, as illustrated in FIG. 2. At the same time, type images J1 and J2 that represent that the radiation images are non-CAD processed images, that is, “CAD:_”, are displayed at the lower right and the lower left portion of the display screen of the display section 32 corresponding to each of the radiation images P1 and P2.

[Obtaining Diagnostic Image Data Sets from the CAD Processing Apparatus]

The readout apparatus 10 reads out radiation image information from recording media, and obtains a pair of diagnostic image data sets that represent mammograms of the right and left breasts of a patient. The pair of obtained diagnostic image data sets are output to the CAD processing apparatus 50. The CAD processing apparatus 50 administers CAD processes on the diagnostic image data sets input thereto from the readout apparatus 10, according to input requesting CAD processing from the operator. The diagnostic image data sets and CAD process result data are output to the viewer 60. At the viewer 60, the data obtaining section 26 receives the diagnostic image data sets and the CAD process result data output thereto by the CAD processing apparatus. The data judging section 28 judges that the diagnostic image data sets obtained by the data obtaining section 26 are accompanied by CAD process result data.

In response to the judgment by the data judging section 28 that the obtained diagnostic image data sets are accompanied by the CAD process result data, the display control section 30 processes each combination of the diagnostic image data sets and the CAD process result data as follows. In the case that the CAD process result data specifies abnormal patterns, a radiation image, in which the positions of the abnormal patterns are indicated, is generated. In the case that the CAD process result data does not specify abnormal patterns, a radiation image, in which positions of abnormal patterns are not indicated, is generated. Then, the display control section 30 displays the generated images P1′ and P2′ on the same display screen of the display section 32, as illustrated in FIG. 3. At the same time, type images J1′ and J2′ that represent that the radiation images are CAD processed images, that is, “CAD:[number of abnormal patterns]”, are displayed at the lower right and the lower left portion of the display screen of the display section 32 corresponding to each of the radiation images P1′ and P2′.

[Obtaining Diagnostic Image Data Sets from the Database]

The database 40 stores mammograms of the right and left breasts of individual patients as pairs of diagnostic image data sets transmitted thereto from the readout apparatus 10. In addition, the database 40 stores diagnostic image data sets, on which CAD processes have been administered by the CAD processing apparatus 50, and CAD process result data obtained by the cad processes, correlated with each other. The data obtaining section 26 of the viewer 60 searches for a pair of diagnostic image data sets of a specific patient, for example, from among the plurality of diagnostic image data sets stored in the database 40. At this time, CAD process result data correlated to the pair of diagnostic image data sets are also searched for. In the case that CAD process result data correlated to the pair of diagnostic image data sets exist, the data obtaining section 26 obtains both the diagnostic image data sets and the CAD process result data. In the case that CAD process result data correlated to the pair of diagnostic image data sets do not exist, the data obtaining section 26 obtains only the diagnostic image data sets. The data judging section 28 judges whether the diagnostic image data sets obtained by the data obtaining section 26 are accompanied by CAD process result data. The display control section 30 displays non-CAD processed images or CAD processed images based on the judgment results, as described above.

In this manner, according to the second embodiment, information that represents the type of image being displayed, based on whether the data set obtained by the data obtaining section 26 is accompanied by CAD process result data, along with the displayed image, even in cases that there is a plurality of paths through which the diagnostic image data sets are obtained. For this reason, it becomes possible to distinguish whether an image is a non-CAD processed image or a CAD processed image in which abnormal patterns were not detected, by viewing the image, unlike in conventional image display apparatuses. Therefore, positive recognition regarding whether a displayed diagnostic image is a non-CAD processed image, in which detection results of a CAD process are not reflected, or a CAD processed image, in which detection results of a CAD process are reflected, is enabled.

The CAD processing section 24 and the CAD processing apparatus 50 described above execute programs that perform CAD processes.

There are cases in which the programs are updated, in order to improve detection accuracy with respect to abnormal patterns.

There are cases in which each updated algorithm of the program has unique characteristics in the CAD process performed thereby. For example, Version 4.0 of a CAD processing algorithm for mammograms may have the following characteristics: (1) capable of detecting tumor patterns, but not capable of detecting patterns which are not horizontally symmetrical; (2) not capable of detecting distortions without cores (spiculae); and (3) detects blood vessel deposition calcifications as calcification cluster candidates. Meanwhile, Version 5.0 may have the following characteristics: (1) capable of detecting horizontally asymmetrical patterns as well as tumor patterns; (2) capable of detecting most distortions without cores; and (3) does not detect blood vessel deposition calcifications as calcification cluster candidates. Therefore, it is preferable that the CAD processing systems described above display a version image that indicates the version number of the algorithm employed by the CAD processing program, the detection sensitivity with respect to abnormal patterns, the values of various parameters and the like, at all times, or at predetermined times. By adopting this configuration, an operator can view the information indicated in the version image to ascertain the characteristics of the CAD process. Accordingly, more effective diagnostic aiding information can be obtained from the CAD processed images, by taking the characteristics of the CAD process into consideration.

Alternatively, data that indicates the version of the algorithm employed by the CAD processing program may be included in the CAD process result data. In this case, the display control section 30 may display the version image based on the data. If this configuration is adopted, the characteristics of a CAD process, which had been performed on a diagnostic image data set in the past by an older version of the algorithm, can be accurately known.

Note that the version image may be displayed in small regions that do not interfere with observation of radiation images, such as regions V1 and V2 illustrated in FIG. 6. Alternatively, a version image V3 may be provided as a pop up window, when a portion of the type image that represents whether a diagnostic image is a non-CAD processed image or a CAD processed image, for example, the characters “CAD”, is clicked with a mouse or the like.

Recently, CAD processing systems (abnormal pattern detecting systems) have been released by various manufacturers. These CAD processing systems enable pluralities of operating points (balance between detection rates of abnormal patterns and false positive detection rates), that is, detection sensitivities, to be set during the CAD processes performed thereby.

FIG. 8 is a graph illustrating a curve L that indicates the relationship between detection rates of abnormal patterns and numbers of false positive detections (hereinafter, referred to as “CAD performance curve”). As illustrated in FIG. 8, the operating points correspond to points along the CAD performance curve L. In older types of CAD systems, in which the operating points are not variable, they are fixed at the point OP2 along the curve L, for example. In recent CAD systems, in which the operating points are variable, they are switchable among the points OP1, OP2, and OP3 along the curve L, for example.

Generally, if the detection sensitivity of CAD is set at operating point OP1, to detect and mark all candidates of abnormal patterns (cancerous tumors), the likelihood that those patterns which are not abnormal patterns (not cancerous tumors) will be erroneously detected and marked increases. Conversely, if the detection sensitivity of CAD lowered and set at operating point OP3, the number of false positive detections of patterns which are not abnormal patterns decreases. In an ideal CAD process, the percentage of true abnormal patterns, which are detected and marked, is increased, while the percentage of false positive detections of patterns, which are not abnormal patterns, is decreased. However, these two goals cannot be simultaneously achieved, due to the trade off nature of detection sensitivity.

Therefore, sensitivity parameters settings selectable by the operator are provided for the detection sensitivity of CAD processes. The sensitivity parameters settings are Active, Standard, and Moderate, each respectively corresponding to points OP1, OP2, and OP3 along the CAD performance curve L. The detection sensitivity parameter (operating point) of CAD processes are enabled to be switched among the three settings, according to user preference, hospital policy, intended use of the diagnostic images, and the like.

Note that the characteristics and the risks of each of the sensitivity parameter settings are summarized in the table below.

TABLE 1

| Sensitivity | |
|---|---|
| Parameter | |
| Setting | Characteristics and Risks |
| Active | Highest detection sensitivity |
| | Likelihood of marking patterns, which are not |
| | abnormal patterns (cancerous tumors) is |
| | higher than the other two settings |
| Standard | Detection sensitivity between those of |
| (Recommended) | “Active” and “Moderate” |
| | Likelihood of marking patterns, which are not |
| | abnormal patterns (cancerous tumors) is |
| | between that of “Active” and “Moderate” |
| Moderate | Lowest detection sensitivity |
| | Likelihood of marking patterns, which are not |
| | abnormal patterns (cancerous tumors) is lower |
| | than the other two settings |

However, in the present CAD processing systems provided by the various manufacturers, information that represents the operating point employed in yielding CAD process results is not displayed, when the image which is subject to CAD or the CAD process results is displayed. Therefore, the operator is not capable of knowing which operating point was employed in the CAD process. That is, the operator cannot know whether the CAD process results are those obtained by calculations that raise the detection rate, or those obtained by calculations that suppress false positive detections. Therefore, the operator cannot know the characteristics of the CAD process which was administered, and there is a possibility that diagnosis based on the diagnostic image will be flawed. For example, in the case that a CAD system, which is generally utilized at an operating point having a comparatively high detection sensitivity, displays CAD process results which were obtained utilizing an operating point having a comparatively low detection sensitivity, the number of detected abnormal patterns will be less than usual. Therefore, more attention should be paid to patterns which were not detected as abnormal patterns. However, because the operator does not know the sensitivity setting of the CAD process, there is a possibility that diagnosis will be performed on the image as usual, and abnormal patterns will be missed.

In order to solve this problem, a configuration may be adopted, wherein: the CAD process (abnormal pattern detecting process) detects the abnormal patterns employing one of a plurality of operating points (detection sensitivities); the detection process result data includes data that represents the operating point employed in the CAD process administered on the diagnostic image data set; and the display control means 30 also displays information representing the operating point of the CAD process, when displaying the post-detection process image. For example, sensitivity parameter images representing the sensitivity parameter setting (for example, “Std”, “Act”, “Mdr”, or the like) that specifies the operating points of administered CAD processes may be displayed next to the type image.

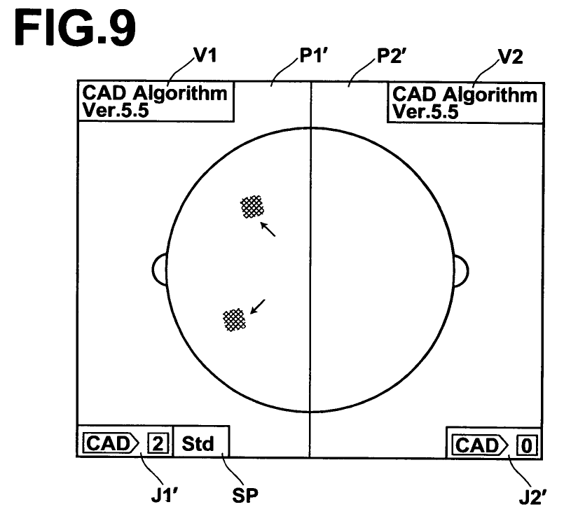

FIG. 9 illustrates the display screen of the display section 32, in which: images P1′ and P2′; type images J1′ and J2′ that respectively represent whether the images P1′ and P2′ are CAD processed images; version images V1 and V2 that represents version data of the program employed in CAD processes; and a sensitivity parameter image SP that represents a sensitivity parameter setting specifying the operating point of the CAD process; are displayed.

If the above configuration is adopted, the operator can know the operating point of the CAD process which was administered. Therefore, a more accurate diagnosis, that takes the characteristics of the CAD process into consideration, can be performed based on the diagnostic image.

Note that the data that represents the operating point need not be displayed in all cases. For example, display may be omitted in the case that the sensitivity parameter setting is “Standard”, or a default initial setting, and the data that represents the operating point may be displayed only if other operating points are set.

In addition, the operating point is not limited to being selected from among a plurality of preset operating points as described above. Alternatively, the operating point may be set as a desired point that moves continuously along the CAD performance curve L. In this case, the data that represents the operating point may be a coordinate value or the like that corresponds to the position of the operating point along the CAD performance curve L.

As a further alternative, the data that represents the operating point may be always displayed on the screen regardless of whether a diagnostic image is being displayed.

What is claimed is:

1. An image display apparatus, comprising:
data obtaining means, for obtaining: a diagnostic image data set that represents a diagnostic image of a subject; and detection process result data, obtained by administering an abnormal pattern detecting process for detecting abnormal patterns within the diagnostic image represented by the diagnostic image data set, including the positions of the abnormal patterns in the case that the abnormal patterns are detected, to accompany the diagnostic image data set; or a diagnostic image data set, which is not accompanied by the detection process result data;
data judging means, for judging whether the data set obtained by the data obtaining means is accompanied by the detection process result data;
display means, for displaying images; and
display control means, for: displaying the diagnostic image data set as a pre-detection process image if the judging means judges that the data set is not accompanied by the detection process result data; for generating and displaying an image that indicates the positions of the abnormal patterns, if the judging means judges that the data set is accompanied by the detection process result data and in the case that the abnormal patterns are specified by the detection process result data; and for generating and displaying an image that does not indicate the positions of abnormal patterns if the judging means judges that the data set is accompanied by the detection process result data and in the case that abnormal patterns are not specified by the detection process result data;
the display control means displays information that represents the type of image being displayed, from between a pre-detection process image type and a post-detection process image type, when displaying the image, based on the judgment results of the data judging means.

2. An image display apparatus as defined in claim 1, wherein:
the detection process result data includes data that represents the number of abnormal patterns detected by the abnormal pattern detecting process; and
the display control means displays the number of the detected abnormal patterns when displaying the post-detection process image.

3. An image display apparatus as defined in claim 1, wherein:
the abnormal pattern detecting process detects the abnormal patterns employing one of a plurality of detection sensitivities;
the detection process result data includes data that represents the detecting sensitivity employed in the abnormal pattern detecting process administered on the diagnostic image data set; and
the display control means also displays information representing the detection sensitivity.

4. An image display apparatus as defined in claim 2, wherein:
the abnormal pattern detecting process detects the abnormal patterns employing one of a plurality of detection sensitivities;
the detection process result data includes data that represents the detecting sensitivity employed in the abnormal pattern detecting process administered on the diagnostic image data set; and
the display control means also displays information representing the detection sensitivity.

5. A computer readable medium having stored therein a program that causes a computer to function as:
data obtaining means, for obtaining: a diagnostic image data set that represents a diagnostic image of a subject; and detection process result data, obtained by administering an abnormal pattern detecting process for detecting abnormal patterns within the diagnostic image represented by the diagnostic image data set, including the positions of the abnormal patterns in the case that the abnormal patterns are detected, to accompany the diagnostic image data set; or a diagnostic image data set, which is not accompanied by the detection process result data;
data judging means, for judging whether the data set obtained by the data obtaining means is accompanied by the detection process result data;
display means, for displaying images; and
display control means, for: displaying the diagnostic image data set as a pre-detection process image if the judging means judges that the data set is not accompanied by the detection process result data; for generating and displaying an image that indicates the positions of the abnormal patterns, if the judging means judges that the data set is accompanied by the detection process result data and in the case that the abnormal patterns are specified by the detection process result data; and for generating and displaying an image that does not indicate the positions of abnormal patterns if the judging means judges that the data set is accompanied by the detection process result data and in the case that abnormal patterns are not specified by the detection process result data; wherein
information that represents the type of image being displayed, from between a pre-detection process image type and a post-detection process image type, is displayed when displaying the image, based on the judgment results of the data judging means.

6. A computer readable medium as defined in claim 5, wherein:
the detection process result data includes data that represents the number of abnormal patterns detected by the abnormal pattern detecting process; and
the display control means displays the number of the detected abnormal patterns when displaying the post-detection process image.

7. A computer readable medium as defined in claim 5, wherein:
the abnormal pattern detecting process detects the abnormal patterns employing one of a plurality of detection sensitivities;
the detection process result data includes data that represents the detecting sensitivity employed in the abnormal pattern detecting process administered on the diagnostic image data set; and
the display control means also displays information representing the detection sensitivity.

8. A computer readable medium as defined in claim 6, wherein:
the abnormal pattern detecting process detects the abnormal patterns employing one of a plurality of detection sensitivities;
the detection process result data includes data that represents the detecting sensitivity employed in the abnormal pattern detecting process administered on the diagnostic image data set; and
the display control means also displays information representing the detection sensitivity.

9. An image display method, comprising the steps of:
obtaining: a diagnostic image data set that represents a diagnostic image of a subject; and detection process result data, obtained by administering an abnormal pattern detecting process for detecting abnormal patterns within the diagnostic image represented by the diagnostic image data set, including the positions of the abnormal patterns in the case that the abnormal patterns are detected, to accompany the diagnostic image data set; or a diagnostic image data set, which is not accompanied by the detection process result data;
judging whether the data set obtained by the data obtaining means is accompanied by the detection process result data;
displaying the diagnostic image data set as a pre-detection process image if it is judged that the data set is not accompanied by the detection process result data; generating and displaying an image that indicates the positions of the abnormal patterns, if it is judged that the data set is accompanied by the detection process result data and in the case that the abnormal patterns are specified by the detection process result data; and for generating and displaying an image that does not indicate the positions of abnormal patterns if it is judged that the data set is accompanied by the detection process result data and in the case that abnormal patterns are not specified by the detection process result data; wherein
information that represents the type of image being displayed, from between a pre-detection process image type and a post-detection process image type, is displayed when displaying the image, based on the judgment results of the data judging means.

10. An image display method as defined in claim 9, wherein:
the detection process result data includes data that represents the number of abnormal patterns detected by the abnormal pattern detecting process; and
the number of the detected abnormal patterns is displayed when displaying the post-detection process image.

11. An image display method as defined in claim 9, wherein:
the abnormal pattern detecting process detects the abnormal patterns employing one of a plurality of detection sensitivities;
the detection process result data includes data that represents the detecting sensitivity employed in the abnormal pattern detecting process administered on the diagnostic image data set; and
information representing the detection sensitivity is also displayed when displaying the post-detection process image.

12. An image display method as defined in claim 10, wherein:
the abnormal pattern detecting process detects the abnormal patterns employing one of a plurality of detection sensitivities;
the detection process result data includes data that represents the detecting sensitivity employed in the abnormal pattern detecting process administered on the diagnostic image data set; and
information representing the detection sensitivity is also displayed when displaying the post-detection process image.
